(19) United States
(12) Patent Application Publication
(10) Pub. No.: US 2004/0204519 A1
(43) Pub. Date: Oct. 14, 2004

(54) Wood filled composites

(76) Inventors: W. Matthew Fender, Dundee, OH (US); Tom Kelley, Dover, OH (US); Victor W. Lee, Dover, OH (US)

Correspondence Address: BUCKINGHAM, DOOLITTLE & BURROUGHS, LLP, 50 S. MAIN STREET, AKRON, OH, 44308, US

(21) Appl. No.: 10/811,638

(22) Filed: Mar. 29, 2004

Related U.S. Application Data
(60) Provisional application No. 60/320,066, filed on Mar. 29, 2003.
(60) Provisional application No. 60/481,284, filed on Aug. 25, 2003.

(51) Int. Cl. C08L 1/00

(52) U.S. Cl. 524/35

(57) ABSTRACT

A chlorinated resin or chlorinated paraffin wax coupling agent is disclosed for enhancing the physical properties while simultaneously lowering the melt viscosity during extrusion of a cellulose-filled thermoplastic polymer composite.

### TECHNICAL FIELD

This invention relates generally to wood-filled thermoplastic composites preferably polyolefins such as high density polyethylene, medium density polyethylene, low density polyethylene, polypropylene as well as polyvinyl chloride in combination with a cellulose-based filler material for use in the decking industry as synthetic wood for example.

### BACKGROUND OF THE INVENTION

In recent years, extruded cellulose-filled thermoplastic materials have been used in many applications, including window and door manufacture as well as decking material as an outlet for plastic scrap. The use of these wood-filled composites is also growing rapidly, as consumers experience the advantages over wood which include low or no routine maintenance and no cracking, warping or splintering. Additive use is also growing as wood-plastic composites penetrate new markets with more stringent performance requirements and as interest in the long-term stability of composite products increases.

It is known in the art to combine different forms of plastic with different forms of natural fibers or flours, non-limiting illustrative examples including wood flour, crushed shells of nuts, kenaf, hemp, jute, sisal, flax and rice hulls and other natural materials. The purpose of such previous combinations has been to enhance the physical properties and lower the cost of the product. However, such materials have not been successfully used in the form of a structural member that is a direct replacement for wood. Typical common extruded thermoplastic materials have been found not to provide equivalent or acceptable structural properties similar to wood or other traditional structural materials. Accordingly, a substantial need exists for a composite material that can be made of polymer and wood fiber and/or wood flour with an optional, intentional recycle of a waste stream. A further need exists for a composite material that can be extruded into a shape that is a direct substitute for the equivalent milled shape in a wooden or metal structural member. This need requires a material that can be extruded into reproducible stable dimensions, a high compressive strength, an improved resistance to insect attack and rot while in use, and a hardness and rigidity that permits sawing, milling and fastening retention comparable to wood.

Further, companies manufacturing wood-based products have become significantly sensitive to waste streams produced in the manufacture of such products. Substantial quantities of wood waste, including wood trim pieces, sawdust, wood milling by-products, recycled thermoplastic including recycled polyvinyl chloride, have caused significant expense to various manufacturers. Commonly, these materials are either burned for their heat value in electrical generation, or are shipped to qualified landfills for disposal. Such waste streams are contaminated with substantial proportions of hot melt and solvent-based adhesives, waste thermoplastic such as polyvinyl chloride, paint, preservatives, and other organic materials. A substantial need exists to find a productive, environmentally compatible process for using such waste streams for useful structural members and thus, to avoid returning the materials into the environment in an environmentally harmful way.

Therefore, the prior art teaches that conventional structural member applications have commonly used wood, metal and thermoplastic composites or a combination thereof.

The present invention relates to a new and improved process and composition which provides intimate contact of the wood flour to the plastic matrix, improved dimensional integrity of the composite, and decreased melt viscosity during processing. The invention improves over the use of traditional coupling agents which are typically maleic anhydride grafted polymers, in which the functional group bonds to the more polar wood fibers. However, the benefit of using this class of coupling agents has not been generally realized due to its cost.

### SUMMARY OF THE INVENTION

Accordingly it is a principal object of the invention to provide an alternative to existing coupling agents which simultaneously provides: lubrication (it contains both internal and external lubricant systems) with a lower viscosity of wood flour and resin at processing temperatures; surfactant capability in that it provides a wetting out of the wood flour for intimate contact of the wood flour to polymer; and superior adhesion in that the internal bond strength of the overall composite is improved.

It is an object of this invention to use chlorinated paraffin waxes such as Chlorez® as the coupling agent to reduce moisture absorption of the composite, reduce swelling, improve adhesion as well as improve internal bond strength in addition to acting as a processing aid.

It is another object of this invention to use coupling additives as processing aids in conjunction with other lubricants, e.g., ethylene bis-stearamide, stearate esters or fatty acid esters, etc., to increase the bond strength and improve processing of wood-filled composites in a single package sold commercially under the name Doverbond®.

It is still another object of this invention to use Doverbond® formulations to achieve a much lower extruder torque than comparative examples without Doverbond®.

It is still yet another object of this invention to show the use of Doverbond® formulations wherein the Doverbond® formulation acts both as an internal wetting (compatibilizer) agent as well as a flow enhancer.

It is a further object of this invention to demonstrate the use of Doverbond® formulations which give higher internal strength values as measured by greater flex modulus.

These and other objects of the present invention will become more readily apparent from a reading of the following detailed description taken in conjunction with the accompanying drawings and with further reference to the appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a rheology comparison at 190° C. bargraph of Torque (mg) measurements taken at 6 minutes into Brabender® rheology evaluations;

FIG. 2 is a flexural modulus bargraph of the modulus of elasticity (MOE) measurements (×1000 psi) evaluated on an Instron® 4200, average of five samples;

FIG. 3 is a tensile properties bargraph of tensile stress at maximum load (psi) evaluated on an Instron®4200, average of five samples;

FIG. 4 is a torque rheology evaluation of DB4000 on a Brabender® Plasticorder; and

FIG. 5 is a torque rheology evaluation of zinc stearate/ethylene bis-stearamide (EBS) on a Brabender® Plasticorder.

### DETAILED DESCRIPTION OF THE INVENTION

Referring now to the drawings wherein the showings are for purposes of illustrating the preferred embodiment of the invention only and not for purposes of limiting the same, the Figures show a synergistic effect when using chlorinated resins, e.g., Chlorez® and certain wood flour and/or wood fiber composites in polymeric composite compositions. This synergy allows for lower processing torque which translates to higher throughput rates as well as improved final physical properties in a cost-competitive one-package system. This is very important in that many thermoplastic extruders are running at essentially full capacity. Reducing processing torque increases extruder output without any corresponding increase in extrusion lines, thereby enabling each line to run more profitably.

The primary processing mode of making these composites is extrusion where the wood fiber or flour is mixed with molten polymer, typically polyolefin or PVC (although other thermoplastics are envisioned within the scope of this invention) and then extruded. It is important to have additives in the compound to promote coupling and lubricity. These coupling and lubricity additives are very important. The polymer/wood fiber and/or flour blend is extruded at fairly low temperatures of 180° C., due to the heat sensitivity of the wood fibers or wood flour. Without the use of lubricants or coupling agents, it is difficult to extrude a smooth composite having good physical properties. The use of coupling agents and lubricants helps to improve the long term performance of the composite. Use of proper coupling agents reduces water absorption and helps maintain mechanical properties after exposure to water. Coupling agents also improve tensile strength, impact strength, and creep resistance. The goal is to always try and optimize cost performance with additives. Currently maleated polypropylene or maleated polyethylene are used as coupling agents. This current invention discloses the use of chlorinated resins as low-cost processing aids. Unexpectedly, while only increased extruder output was sought, improved internal bond strength of the composite was also demonstrated.

CHLOREZ® is a registered United States trademark of the Dover Chemical Corporation, and HORDARESIN® (European trademark associated with same family of products) and is a family of solid resinous chlorinated paraffins which are especially soluble in aromatic and chlorinated solvents. They have limited or no solubility in lower alcohols, glycols, glycerins and water. Chlorinated paraffins are chlorinated derivatives of n-alkanes, having carbon chain lengths ranging from 10 to 38, and a chlorine content ranging from about 30 to 70-75% (by weight). The products vary in the distribution, possibly type, range of chain lengths, and in the degree of chlorination. The melting point of chlorinated paraffins increases with increasing carbon chain length and with increasing chlorine content. Consequently, at room temperature, chlorinated paraffins range from colorless to yellowish liquids at about 40% chlorine, to white solids (softening point at about 90° C.) at 70% chlorine. Chlorinated paraffins have very low vapor pressures (e.g., 1.3×10⁻⁴ Pa for C₁₄₋₁₇, 52% Cl at 20° C.) and solubilities in water, the latter ranging from 95 to 470 microgram/liter for some of the short chain mixtures (C₁₀₋₁₃) to as low as 3.6 to 6.6 micrograms/liter for some of the longer chain mixtures (C₂₀₋₃₀). In a preferred embodiment, the resin will be chlorinated to between approximately 30-75%. In a more preferred embodiment, the resin will be chlorinated to between approximately 40-75%. In a still more preferred embodiment, the resin will be chlorinated to between approximately 50-75%. In a most preferred embodiment, the resin will be chlorinated to between approximately 68-72%. In this embodiment, the resin will be a solid.

Traditional wood-filled composites are comprised of primarily four components: (a) polymer resin; (b) wood flour or fiber (depending on the mesh size and aspect ratio of the wood-based filler); (c) lubricant/processing aid; and (d) coupling agents. Optionally, other additives such as colorants, ultra-violet degradation inhibitors; anti-fungicidal components; and anti-microbial components are blended into the composite.

One of the keys to the functional performance of the coupling agent is to provide intimate contact of the wood flour with the plastic matrix. It is also used to improve the dimensional integrity of the composite as well as decrease the melt viscosity during processing. The most commonly used coupling agents in the Prior Art are maleic anhydride grafted polymers which are employed as a surfactant, wherein the functional group bonds are used to bond to the polar wood fiber. These additives are not used extensively, primarily due to cost, particularly since no economically realized performance benefit is demonstrated for the increased cost.

Through the use of the Doverbond® formulations, this coupling agent acts as a lubricant in that it: contains both internal and external lubricant systems, leading to a lowered viscosity of the wood flour and resin composite at processing temperatures; acts as a surfactant, providing a “wetting out” of the wood component for intimate contact between the wood flour or fiber and polymer; and improves adhesion by providing improvements in internal bond strength of the overall composite.

Experimentally, a 0.55 MFI High Density Polyethylene (HDPE) sold commercially under the trademark Fortiflex® B53-35H-FLK from BP Solvay, was used in the evaluations and loaded according to Table 1. The natural filler is un-dried 40-mesh hardwood Maple flour from American Wood Fibers, loaded at 60% in all formulations. The experimental systems were all tested against a standard 1:1 ratio of ethylene bis-stearamide (EBS) wax and zinc stearate, loaded at 5%, and a control system consisting of 40% HDPE and 60% Maple flour. Each experimental Doverbond® system was run individually, loaded at 5%, and again with an additional process aid loaded at 3%, see Table 1.

TABLE 1

| | | DB⁽⁵⁾ | DB | DB | DB | DB | DB | DB | |
|---|---|---|---|---|---|---|---|---|---|
| Formula | Standard | 1000 | 2000 | 2300 | 3000 | 3300 | 4000 | 4300 | Control |
| HDPE | 35 | 35 | 35 | 32 | 35 | 32 | 35 | 32 | 40 |
| Maple Flour | 60 | 60 | 60 | 60 | 60 | 60 | 60 | 60 | 60 |
| Chlorez ® | | 5 | 2.5 | 2.5 | 2.5 | 2.5 | 4 | 4 | |
| ZnSt/EBS 1/1 | 5 | | | | | | | | |
| Lubricant A⁽¹⁾ | | | 2.5 | 2.5 | | | | | |
| Lubricant B⁽²⁾ | | | | | 2.5 | 2.5 | | | |
| Lubricant C⁽³⁾ | | | | | | | 1 | 1 | |
| Process Aid⁽⁴⁾ | | | | 3 | | 3 | | 3 | |
| (%) | 100 | 100 | 100 | 100 | 100 | 100 | 100 | 100 | 100 |

⁽¹⁾ethylene bis-stearamide
⁽²⁾pentaerythritol tetrastearate
⁽³⁾polyethylene glycol (PEG) monostearate (M.W. = 1500)
⁽⁴⁾talc
⁽⁵⁾the reference to DB pertains to the additives exclusive of the thermoplastic and cellulose-based filler.

Flexural modulus samples were accurately weighed and mixed by hand according to Table 1, in 1100 g “batches.” Each sample was compounded in a Banbury® mixer set at 180° C. for 5 minutes. Each sample was immediately removed and compression molded at 190° C./25,000 psi for 5 minutes and cooled for 15 minutes @ 25,000 psi. The size of the finished sample was 6″ ×6″ ×0.25″. Each sample was then cut into bars measuring 5″ ×0.50″ ×0.25″ for testing. Flexural modulus, or modulus of elasticity (MOE), was measured according to ASTM D-790 Method 1. Tensile properties were measured on Type-I test bars in accordance with ASTM D-638, on samples cut from the previously mentioned compression-molded plaques.

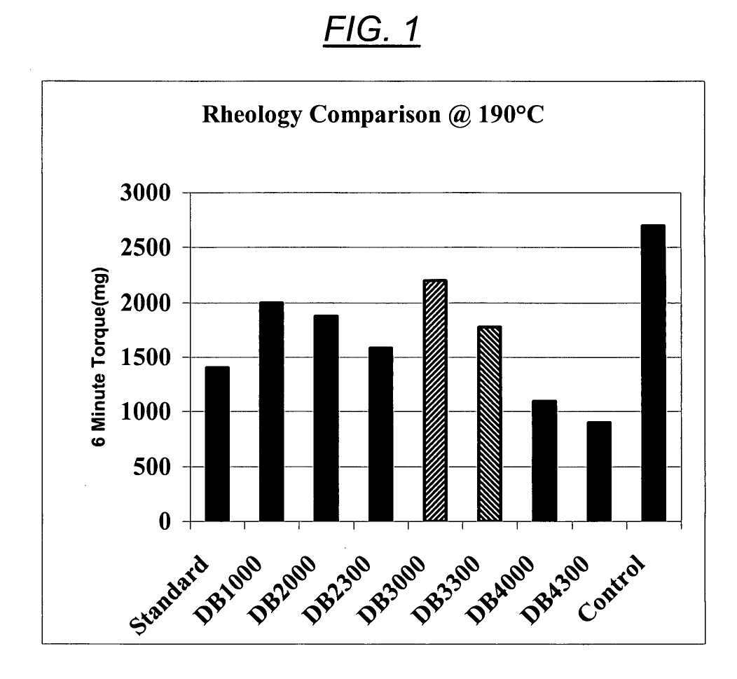

Rheology measurements were performed on 50-gram samples prepared according to Table 1. Meter-grams of torque (mg) and temperature (° C) measurements were derived from evaluations performed on a Brabender® Plasticorder PL2000 3-zone mixing bowl. Baseline torque measurements were derived from the reading taken at 6 minutes into each evaluation; this was kept constant throughout the study and reported in FIG. 1. The mixing bowl temperature was set at 190° C. and at a speed of 60 rpm; the samples ran for 20 minutes each before the test was terminated. The tested sample was then removed from the mixing bowl and compression molded into a 3″ ×3″ plaque at 190° C. for 2 minutes to compare relative heat stability based on color generation.

Referring now to the drawings wherein the showings are for the purpose of illustrating a preferred embodiment of the invention only and not for the purpose of limiting same, there is shown a significant improvement in final physical properties in cellulose-filled plastic composites as well as significant improvements in viscosity reduction which results in improved extruder throughput when Doverbond® is added to the composite.

The Doverbond® product is a multi-component one-pack system where an individual component aids in only one of the above property areas. These property areas are positively quantified by an increase in flexural modulus, an increase in tensile strength or a decrease in torque. The most effective one-pack system will then have a positive effect on all three property areas.

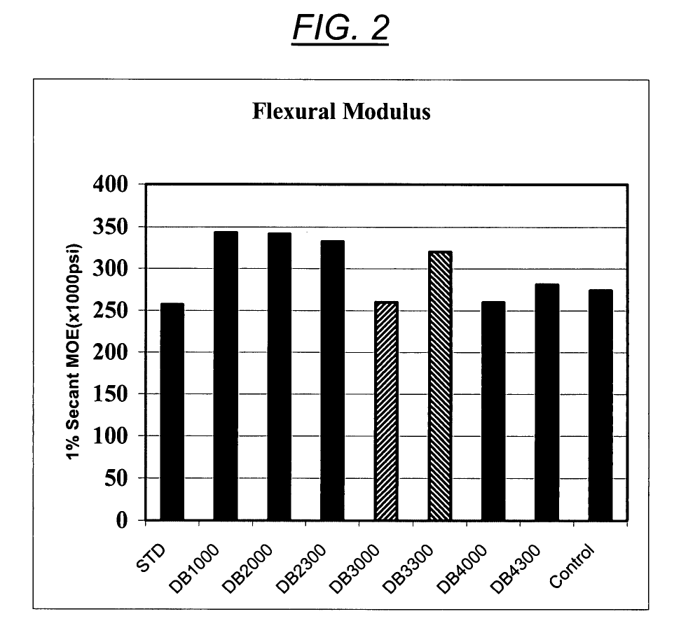

DB1000, which is the base coupling agent component for the entire Doverbond® line, is extremely effective at increasing both the flexural modulus and tensile strength over that of the standard system, as shown in FIGS. 2 & 3 respectively. This coupling effect is demonstrated when the standard system is replaced with DB1000, a 64% increase in tensile strength and a 34% increase in flexural modulus is resulted. The only drawback then, is the increase in torque associated with this action.

Three different lubricant chemistries where evaluated, Lubricants A, B, and C, as shown and identified in Table 1. The overall additive system loading was kept constant at 5% and the coupling agent and lubricant package ratios were varied.

The 1:1 addition of the coupling agent to Lubricant A (DB2000) resulted in an increase in tensile strength and flexural modulus, but the lubricating effect was not realized, as shown in FIG. 1.

The 1:1 addition of the coupling agent to Lubricant B (DB3000) demonstrated similar results, where flexural modulus was maintained and tensile strength was improved, compared to the standard system; FIGS. 2 & 3 respectively.

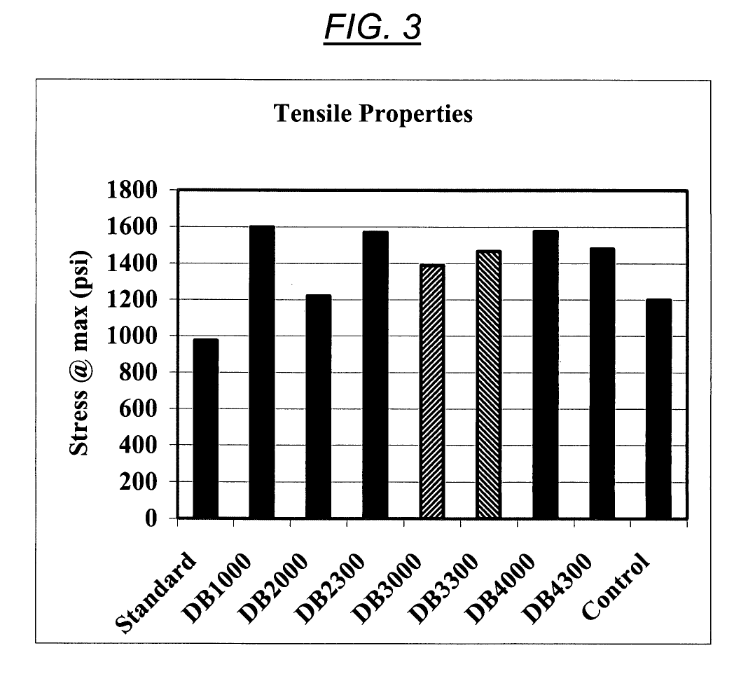

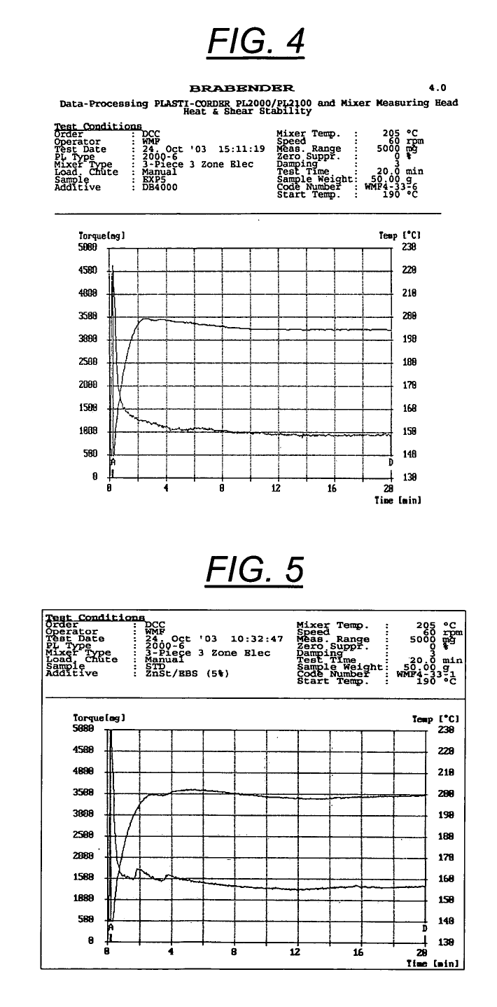

The 4:1 addition of the coupling agent to Lubricant C (DB4000) shows the effectiveness of this lubricant chemistry. Lubricant C was only loaded at 1% to the overall formulation, compared to 2.5% of the other lubricants, Table 1. The DB4000 system outperformed the standard formulation in all required categories; the torque was reduced by 22% (FIG. 1), flexural modulus was maintained (FIG. 2), and the tensile strength was increased by 62% (FIG. 3). Another interesting aspect of the DB4000 system is the improvement in thermal stability. Compare the Brabender chart in FIG. 4 with that of the standard formulation in FIG. 5. Note the “flat-line” effect with the DB4000, indicative of a highly stable system, even after running for 20 minutes at 190° C. set point. Also worthy of note is the drop in temperature, which displays the effectiveness of Lubricant C as well, shown in FIG. 4. This temperature drop is typically due to the reduction of shear forces associated with processing. The effect of temperature reduction coupled with the drop in torque throughout the entire test is exhibited in the pressed plaques of the actual tested samples.

Another series of tests were performed where a process aid was added in addition to the previously outlined formulations; see Table 1.

The addition of the process aid to the system containing Lubricant A showed a positive synergy where torque was significantly reduced, FIG. 1, and tensile properties were increased, FIG. 2. Flexural modulus was not greatly affected.

This synergy was noticed more in conjunction with Lubricant B where all three important categories showed an improvement over the DB3000 system. Comparing to the standard formulation, DB3300 showed a 27% increase in flexural modulus (FIG. 2) and a 50% increase in tensile strength (FIG. 3). The melt viscosity remained at a 27% increase over standard.

The addition of the process aid to Lubricant C (DB4300) displayed marked improvements in all categories when compared to the industry standard formulation. DB4300 presents a system that can offer a 36% reduction in torque (FIG. 1), a 9% increase in flexural modulus (FIG. 2), and a 52% increase in tensile strength as seen in FIG. 3. A similar effect, as previously discussed, was also noticed where the color retention of the tested sample was improved. Therefore, one-pack systems can be designed to incorporate coupling agents, lubricants, and process aids, which result in improved mechanical properties and potentially better flow rates.

While chlorinated resins are believed to be the preferred coupling agent, in some instances, it is desirable to add additional coupling agents, e.g., interfacial agents which aid with the intimate blending of the dissimilar surfaces of wood flour (hydrophilic) and polymer (hydrophobic). The interfacial agent acts as a polymeric surfactant and aids in the formation of the polymer/wood flour blend through its dual functionality of having at least one portion of the moiety being hydrophilic and at least one other portion of the molecule being hydrophobic. Perhaps phrased another way, the moiety must be functionalized to the extent wherein at least one part of the molecule can bond either in a chemical or a physical sense, to at least the cellulose component of the wood flour while at least one other portion of the molecule can mix and/or compatibilize with the polymer.

The impact of lower levels of chlorinated resins were analyzed in Table 2 in which a Brabender® study was run in the bowl at 175° C. for 20 minutes. Samples were pulled at 2, 6, 10, and 20 minutes. The color progression of all samples looked the same. All held good color. Banbury® batches were prepared of each formulation, 175° C. for 5 minute mixing cycle. Physical properties were measured from test specimens cut from plaques compression molded to 0.25 inch thickness. The formulations, torques, and properties are as follows.

TABLE 2

| Formula | Standard | A | B | C | D | E | E | F | G | H | I |
|---|---|---|---|---|---|---|---|---|---|---|---|
| HDPE | 35 | 35 | 32 | 35 | 32 | 35 | 32 | 35 | 35 | 35 | 32 |
| Maple Flour | 60 | 60 | 60 | 60 | 60 | 60 | 60 | 60 | 60 | 60 | 60 |
| Chlorez ® | | 2.5 | 2.5 | 2.5 | 2.5 | 4 | 4 | | | | |
| CPE⁽⁵⁾ | | | | | | | | 5 | 2.5 | 2.5 | 2.5 |
| Zn₂O | 2.5 | | | | | | | | | | |
| Lubricant A⁽¹⁾ | 2.5 | 2.5 | 2.5 | | | | | | | | |
| Lubricant B⁽²⁾ | | | | 2.5 | 2.5 | | | | 2.5 | | |
| Lubricant C⁽³⁾ | | | | | | 1 | 1 | | | 2.5 | 2.5 |
| Process Aid⁽⁴⁾ | | | 3 | | 3 | | 3 | | | | 3 |
| (%) | 100 | 100 | 100 | 100 | 100 | 100 | 100 | 100 | 100 | 100 | 100 |
| Torque (6 min) | 627 | 689 | 590 | 863 | 721 | 799 | 610 | 1441 | 1712 | 746 | 640 |
| Tensile (psi) | 975 | 1220 | 1570 | 1400 | 1470 | 1500 | 1480 | 2100 | 1840 | 1400 | 1340 |
| Elongation (%) | 0.77 | 1.1 | 0.4 | 0.9 | 0.76 | 1.4 | 0.6 | 1.0 | 1.6 | 1.3 | 0.5 |
| Flex Modulus | 257 | 341 | 331.6 | 260 | 319.8 | 259.3 | 281.4 | 223.3 | 209.2 | 167.2 | 180 |
| (psi × 10³) | | | | | | | | | | | |

⁽¹⁾ethylene bis-stearamide
⁽²⁾pentaerythritol tetrastearate (PES-125)
⁽³⁾polyethylene glycol (PEG) monostearate (M.W. = 1500)
⁽⁴⁾talc
⁽⁵⁾36% chlorinated polyethylene.

It is envisioned that a number of polymers are capable of acting as an interfacial agent between the cellulose surfaces in the wood flour, which have a high hydroxy content, and the polymer phase, e.g., polyvinyl chloride. Without being limited to any one theory, it is believed that the interfacial agent adsorbs on the surface of the cellulose particles and makes that surface “look” more polymer-like to the surrounding polyvinyl chloride. Hence, any polymeric compound likely to physisorb or chemisorb on cellulose is believed to provide the desired interfacial blending necessary to effectively form the desired product blend.

Various copolymers effective in this application would include copolymers of ethylene and acrylic acid, i.e. poly(ethylene-co-acrylic acid), (—CH₂CH₂—)ₓ [—CH₂CH(CO₂H)—]_{y}, commercially available with varying acrylic acid content. One of the keys to the efficacy of this group of compounds is the “-co-acrylic acid” or similar type of polymer grouping. Other promising candidates of this sort would include: poly(ethylene-co-methacrylic acid), poly(ethylene-co-methyl acrylate-co-acrylic acid), poly(methyl methacrylate-co-methacrylic acid), and poly(tert-butyl crylate-co-ethyl acrylate-co-methacrylic acid).

Another characteristic believed to play a role in the efficacy of the interfacial agent is its hydroxy content. Assuming physisorption is the predominant mechanism, then compounds which are believed to aid in the composition would include: poly(styrene-co-allyl alcohol), and poly(vinyl alcohol-co-ethylene).

Without being held to any one theory of operation, it is believed that when chemisorption is at least one of the operative modes of this invention regarding the interfacial agent and the cellulose, then any carboxylic acid group containing polymer will have at least some degree of efficacy in this system. Additionally, ester bonds can be formed from amides, acrylates, acyl haldes, nitriles and acid anhydrides reacting with hydroxyl groups. Additional representative polymers would include: poly(vinyl chloride), carboxylated, poly(vinyl chloride-co-vinyl acetate-co-maleic an hydride), and various-co-maleic acid or-graft-maleic acid polymers, of which there are many.

Amides will react with alcohols under acidic conditions to produce an ester and an ammonium salt, rather than water as in the case with carboxylic acids, of which representative examples would include: polyacrylamide, and poly(acrylamide-co-acrylic acid), although the hygroscopic qualities of these polymers somewhat diminish their effectiveness in this application.

Another chemistry which is applicable is that of the acrylates, which are a subset of esters. It would be possible to form an ester bond with an alcohol producing another alcohol in a transesterification reaction. For example, a methacrylate containing polymer could react with the surface hydroxyl to form the surface ester bond and methanol. Representative examples would include: poly(methyl methacrylate), poly(ethyl methacrylate), poly(ethylene-co-ethyl acrylate), and poly(butyl acrylate).

It is also known that acyl halides can react with an hydroxyl group to yield the ester bond and HCl. Another reaction chemistry would include that of a nitrile with a hydroxyl group under acidic conditions to yield the ester bond and an ammonium salt. Representative examples would include: polyacrylonitrile; and poly(acrylonitrile-co-butdiene), particularly when the above poly(acrylonitrile-co-butadiene) is functionalized via amine termination or carboxylation.

Another reaction which is possible is via an acid anhydride which reacts with a hydroxyl group to give the ester bond and an ester. A representative example would include: poly(ethylene-co-ethyl acrylate-co-maleic anhydride).

Another family of block copolymers which are believed to be effective in this composition would be those formed with polyacrylic or polymethyacrylic acid, e.g., polystyrene di-block copolymers such as polystyrene-b-polyacrylic acid and polystyrene-b-polymethacrylic acid. Other candidates include block copolymers with polyvinyl alcohol or polyoxyethylene.

Once again, without being limited to any one theory of operation, it is conceivable that any hydroxyl, hydroxy or acid functionalized low to medium molecular weight polymers may serve as compatibilizers in this system, e.g., hydroxyl functionalized polybutadiene [CAS 69102-90-5]. Other compounds which may act similarly would include poly(vinyl chloride-co-vinyl acetate), poly(vinyl chloride-co-vinyl acetate-co-2-hydroxypropyl acrylate), poly(vinyl chloride-co-vinyl acetate-co-maleic acid).

As used in this application, the term cellulose-based is meant to include all types of material containing cellulose, a non-limiting example listing including wood flour, wood fiber, rice hulls, cotton, wool, bamboo, sisal, kenaf, jute, crushed shells of nuts, hemp, flax and other natural materials etc. The targeted mesh size of the cellulose-based filler is dependent upon the end-use application, and both flour and fiber forms of cellulose are envisioned to be applicable. In some embodiments, synthetic fibers may also be used in conjunction with the cellulose-based fibers, e.g., polyester or aramide as well as inorganic fibers (chopped or long), for example, glass fibers, carbon fiber and ceramic fibers. The amount of cellulose-containing material can vary widely, with ranges from 10-80% by weight of the molded or extruded articles.

Many lubricants are applicable for use in this invention, a non-limiting illustrative list including: metal soaps, hydrocarbon waxes, fatty acids, long-chain alcohols, fatty acid esters, particularly esters of long chain (C₁₆ to C₂₄) fatty acids with polyalkylene glycols, fatty acid amides, silicones, fluorochemicals, acrylics, and mixtures thereof. Preferred are long chain fatty acids (e.g., stearic, oleic, palmitic, lauric, tallow acids, etc.) with polyalkylene or polyoxyalkylene glycols (e.g., polyethylene glycol, polypropylene glycol, etc.) to form polyalkylene mono- or di-esters. These preferred lubricants have surfactant characteristics and are generally nonionic. As general guidance it is preferred that these lubricants when used in the preparation of formulations of this invention be selected from those surfactants classified as anionic or nonionic. These surfactants are particularly useful for their compatibility and stability. Surfactants generally suitable for the various purposes in the present invention include long chain (C₁₆ to C₂₄) fatty acids, e.g. palmitic acid, stearic acid and oleic acid; esters of long chain (C₁₆ to C₂₄) fatty acids, e.g. sodium palmitate, sodium stearate and sodium oleate; sodium lauryl sulphate; polyethylene glycol; polyethylene glycol alkyl ethers; fatty acid esters of polyethylene glycol, e.g. polyethylene glycol mono- or di-stearate; propylene glycol; fatty acid esters of propylene glycol, e.g. propylene glycol monostearate; glycerine; fatty acid mono- or poly-glycerides, such as glyceryl monostearate; polyoxyethylene fatty acid esters, ethers and amines, e.g. polyoxyethylene mono- and di-stearate, and polyoxyethylene lauryl ether; polyoxyethylene sorbitan esters, e.g. polyoxyethylene sorbitan monolaurate, monopalmitate, monostearate or mono-oleate; polyoxyethylene alkyl phenols and alkyl phenyl ethers; polyoxyethylene castor oil; sorbitan fatty acid esters; the polysorbates; stearylamine; triethanolamine oleate; vegetable oils, e.g. sesame seed oil or corn oil; cholesterol; and tragacanth. The amount of lubricants is from 0.1% to 20% by weight of the molded or extruded articles, more preferably 0.1 to 4%, most preferably 1 to 3% by weight.

Many thermoplastic resins are applicable in this invention, a non-limiting illustrative list including polyolefins: such as polypropylene, polyethylene and polybutenes, as well as diolefins, e.g., polybutadiene and isoprene; acrylonitrile-styrene-butadiene block copolymers; polystyrene; polyamides such as nylons; polyesters; polyvinyl chloride; polycarbonates; acryl resins and thermoplastic elastomers such as EPDM (ethylene propylene diene copolymers), and they are used singly or as a mixture thereof, or as a polymer alloy using them. Among them, polyethylene and polypropylene are preferred.

As illustrated above, while chlorinated paraffin waxes are the preferred coupling agent, many others as discussed previously are applicable to supplement the chlorinated wax base agent, including mixtures thereof. The percent of chlorination in the coupling agent can vary widely, with chlorine contents ranging from about 30% to 70-75%. Preferably, the chlorinated wax is a solid, most preferably, a paraffin wax sold commercially by the Dover Chemical company under the trademark Chlorez® having a chlorine content of about 68-72%. The amount of coupling agent (interfacial bonding agent and/or surfactant) is from 0.1% to 10% by weight of the molded or extruded articles, preferably from 1 to 8%, 11 and more preferably from 3-5%.

When used, the processing aid is a is a nucleating agent selected from the non-limiting illustrative list of of polyhydroxybutyrate, sorbitol acetal, boron nitride, titanium oxide, talc, clay, calcium carbonate, sodium chloride, metal phosphate, and mixtures thereof. The amount of processing aid is from 0.1% to 30% by weight of the molded or extruded articles, typically approximately 10% by weight.

In addition, various kinds of conventionally used stabilizers, pigments and antistatic agents may be compounded as necessary, and depending on the intended use, various kinds of other modifiers for example, surface characteristic modifiers such as gloss agents, antistatic agents and surface processing assistants as well as biological characteristic modifiers such as antimicrobial agents, anti-fungus agents and preservatives may be compounded as necessary.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the invention is by way of example, and the scope of the invention is not limited to the exact details shown or described.

This invention has been described in detail with reference to specific embodiments thereof, including the respective best modes for carrying out each embodiment. It shall be understood that these illustrations are by way of example and not by way of limitation.

What is claimed is:

1. A polymer composite which comprises:
(a) a cellulose-based polymer filler;
(b) a chlorinated resin coupling aid said resin chlorinated to between approximately 30-75%; and
(c) a thermoplastic polymer.

2. The composite of claim 1 which further comprises a lubricant.

3. The process of claim 2 wherein said lubricant is selected from the group consisting of metal soaps, hydrocarbon waxes, fatty acids, long-chain alcohols, fatty acid esters, fatty acid amides, silicones, fluorochemicals, acrylics, and mixtures thereof.

4. The process of claim 3 wherein said lubricant is a polyalkylene glycol fatty acid ester.

5. The composite of claim 2 wherein said resin is chlorinated to between approximately 40-75%.

6. The composite of claim 3 wherein said resin is chlorinated to between approximately 50-75%.

7. The composite of claim 4 wherein said resin is chlorinated to between approximately 60-75%.

8. The composite of claim 5 wherein said resin is chlorinated to between approximately 68-72%.

9. The composite of claim 5 wherein said resin is about 4% by weight of said composite.

10. The composite of claim 7 which further comprises a processing aid.

11. The composite of claim 8 wherein said processing aid is talc.

12. The composite of claim 9 wherein
(a) said processing aid is approximately 4 weight percent; and
(b) said filler is approximately 60 weight percent.

13. A process for improving extruder output of a cellulose and thermoplastic composite comprising the step of:
(a) adding between approximately 0.1% to 10% by weight of a chlorinated resin, said resin chlorinated to between approximately 30-75%.

14. The process of claim 11 wherein said resin is chlorinated to between approximately 60-75%.

15. The process of claim 12 wherein said resin is chlorinated to between approximately 68-72%.

16. The process of claim 12 which further comprises the step of adding a lubricant.

17. The process of claim 16 wherein said lubricant is selected from the group consisting of metal soaps, hydrocarbon waxes, fatty acids, long-chain alcohols, fatty acid esters, fatty acid amides, silicones, fluorochemicals, acrylics, and mixtures thereof.

18. The process of claim 17 wherein said lubricant is a polyalkylene glycol fatty acid ester.

19. The process of claim 16 which further comprises the step of adding a processing aid.

20. A process for improving a cellulose and thermoplastic composite by reducing extruder torque during processing while essentially maintaining flexural modulus of said extruded composite and increasing the tensile strength of said extruded composite comprising the step of:
(a) adding between approximately 0.1% to 10% by weight of a chlorinated resin, said resin chlorinated to between approximately 50-75%, said properties compared to a composite without any added chlorinated resin.

21. The process of claim 16 wherein said resin wherein said resin is chlorinated to between approximately 60-75%.

22. The process of claim 17 wherein said resin is chlorinated to between approximately 68-72%.

23. The process of claim 17 which further comprises the step of adding a lubricant.

24. The process of claim 23 wherein said lubricant is selected from the group consisting of metal soaps, hydrocarbon waxes, fatty acids, long-chain alcohols, fatty acid esters, fatty acid amides, silicones, fluorochemicals, acrylics, and mixtures thereof.

25. The process of claim 24 wherein said lubricant is a polyalkylene glycol fatty acid ester.

26. The process of claim 21 which further comprises the step of:
(a) adding a processing aid.

27. A polymer composite which comprises:
(a) a cellulose-based polymer filler;
(b) a coupling aid which comprises:
(i) a chlorinated resin, said resin chlorinated to between approximately 30-75%;
(ii) an interfacial bonding agent, said agent comprising a hydrophilic component and a hydrophobic component; and
(c) a thermoplastic polymer.

28. The composite of claim 27 wherein said chlorinated resin is chlorinated to between approximately 50-75%.

29. The composite of claim 28 wherein said chlorinated resin is chlorinated to between 68-72%.

30. The composite of claim 29 wherein said interfacial bonding agent is selected from the group consisting of metal soaps, hydrocarbon waxes, fatty acids, long-chain alcohols, fatty acid esters, fatty acid amides, silicones, fluorochemicals, acrylics, and mixtures thereof.

31. The composite of claim 30 wherein said interfacial bonding agent is selected from the group consisting of particularly esters of C₁₆ to C₂₄ fatty acids with polyalkylene glycols or polyoxyalkylene glycols.

32. The composite of claim 31 wherein said interfacial bonding agent is nonionic.

33. The composite of claim 32 wherein said interfacial bonding agent is the reaction product of a long chain fatty acid selected from the group consisting of stearic, oleic, palmitic, lauric, and tallow acids with a polyalkylene or polyoxyalkylene glycol to form a polyalkylene mono- or di-ester.

34. The composite of claim 31 which further comprises a processing aid.

35. The composite of claim 34 wherein said processing aid is talc.
